(19) United States
(12) Patent Application Publication
(10) Pub. No.: US 2023/0110391 A1
(43) Pub. Date: Apr. 13, 2023

(54) 3D SENSING AND VISIBILITY ESTIMATION

(71) Applicant: Waymo LLC, Mountain View, CA (US)

(72) Inventors: Vincent Michael Casser, Cambridge, MA (US); Bradley Dodson, Seattle, WA (US)

(21) Appl. No.: 17/956,696

(22) Filed: Sep. 29, 2022

Related U.S. Application Data
(60) Provisional application No. 63/250,072, filed on Sep. 29, 2021.

(51) Int. Cl. G06T 7/521

(52) U.S. Cl. CPC G06T 7/521; B60W 60/001; G06T 2207/10028; G06T 2207/20081; G06T 2207/20084; G06T 2207/30252

(57) ABSTRACT

Methods, systems, and apparatus, including computer programs encoded on computer storage media, for determining the visibility of query points using depth estimates generated by a neural network.

### CROSS-REFERENCE TO RELATED APPLICATION

This application claims priority to U.S. Provisional App. Serial No. 63/250,072 filed on Sep. 29, 2021, the disclosure of which is incorporated in its entirety into this application.

### BACKGROUND

This specification relates to predicting visibility of three-dimensional query points in an environment based on a sensor image.

The environment can be a real-world environment, and the query point can be any point in the environment surrounding an agent, e.g., an autonomous vehicle. Predicting visibility of the query point can be a task required for motion planning of the agent.

Autonomous vehicles include self-driving cars, trucks, boats, and aircraft. Autonomous vehicles use a variety of on-board sensors and computer systems to detect nearby objects and use such detections to make control and navigation decisions.

Some autonomous vehicles have on-board computer systems that implement neural networks or other types of machine learning models for various prediction tasks, e.g., object classification within images. For example, a neural network can be used to determine that an image captured by an on-board camera is likely to be an image of a nearby obstruction, e.g., a car or a pedestrian.

### SUMMARY

This specification describes how a computer system can use a neural network to generate visibility predictions for three-dimensional query points located in an environment surrounding an agent. The agent may be any type of vehicle including, for example, cars, trucks, motorcycles, buses, recreational vehicles, amusement park vehicles, farm equipment, construction equipment, trams, golf carts, trains, and trolleys. The agent may be an autonomous vehicle or a semi-autonomous vehicle.

The visibility prediction can be generated from an input image, e.g., a single image, captured by a sensor of the agent, e.g., a camera sensor. The visibility prediction can be a prediction of whether a three-dimensional query point in the environment is visible or not in the single image. In other words, the visibility prediction indicates whether the three-dimensional query point is visible in the image, i.e., whether or not the three-dimensional query point is occluded by an object, out of range of the sensor, or is otherwise not able to be seen in the image.

Particular embodiments of the subject matter described in this specification can be implemented so as to realize one or more of the following advantages.

An autonomous or semi-autonomous vehicle system can use a fully-learned neural network to generate visibility predictions of a scene from an input image captured by a sensor that characterizes the scene. This can allow the vehicle to plan a reliable and safe future motion trajectory. Such visibility prediction advantageously relies on monocular depth estimation based on an image captured by the camera, and does not require any additional depth information of the scene, such as depth maps or lidar or radar readings.

Because cameras can sense significantly farther and at higher angular resolution than lasers or radars, the visibility prediction generated from the camera image can allow prediction for locations that cannot be sensed by lasers or radars. In addition, cameras can be less impacted by adverse weather conditions such as fog or rain than lasers or radars, so that visibility predictions using camera images can be utilized under a wider variety of driving conditions. By using two-dimensional camera pixels and mapping them into three dimensional space in relation to the three-dimensional query points, the computer system can make camera signals more accessible to perception systems, e.g., those that are deployed on-board autonomous vehicles.

The described techniques can also estimate the uncertainty associated with the visibility predictions. Such uncertainty can be used as a quantitative indication of the expected relative amount of error in visibility prediction, and can be used in combination with the visibility predictions for making more robust, reliable, and safer control of the agent, i.e., control that is robust against prediction errors. Further, a safety margin can be customized and multiplied to the estimated uncertainty to enable the agent to move more conservatively or aggressively when needed.

The neural network is advantageously trained using ground truth depths obtained from LiDAR images that can be more accurate and reliable than depths generated using other image sources. The training samples include camera images with a variety of driving conditions and situations, such as with the presence of cyclists or pedestrian crowds, adverse weather, and night scenes.

Further, the neural network can include a depth estimation head and an uncertainty estimation head, and the two heads can be trained on two different parts of the training examples to improve the network’s depth and uncertainty estimation.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIGS. 2A-2C illustrate examples of generating a depth prediction output and corresponding estimated uncertainty output from an image.

FIG. 3A shows an example of the neural network.

FIG. 3B illustrates an example of generating visibility estimates.

FIG. 4 is a flowchart of an example process for generating a visibility output from an image using the neural network.

Like reference numbers and designations in the various drawings indicate like elements.

### DETAILED DESCRIPTION

This specification describes how a computer system can use a neural network to generate visibility predictions for three-dimensional query points located in an environment surrounding an agent. The agent may be any type of vehicle including, for example, cars, trucks, motorcycles, buses, recreational vehicles, amusement park vehicles, farm equipment, construction equipment, trams, golf carts, trains, and trolleys. As a particular example, the agent may be, e.g., an autonomous vehicle.

The visibility prediction can be generated using an input image, e.g., a single image, captured by a sensor of the agent, e.g., a front-facing camera. The visibility prediction can be a prediction of whether a three-dimensional query point in the environment is visible or not. In other words, the visibility prediction indicates whether the three-dimensional query point is visible in the image, i.e., whether the three-dimensional query point is occluded by an object, out of range of the sensor, or is otherwise not able to be seen in the image.

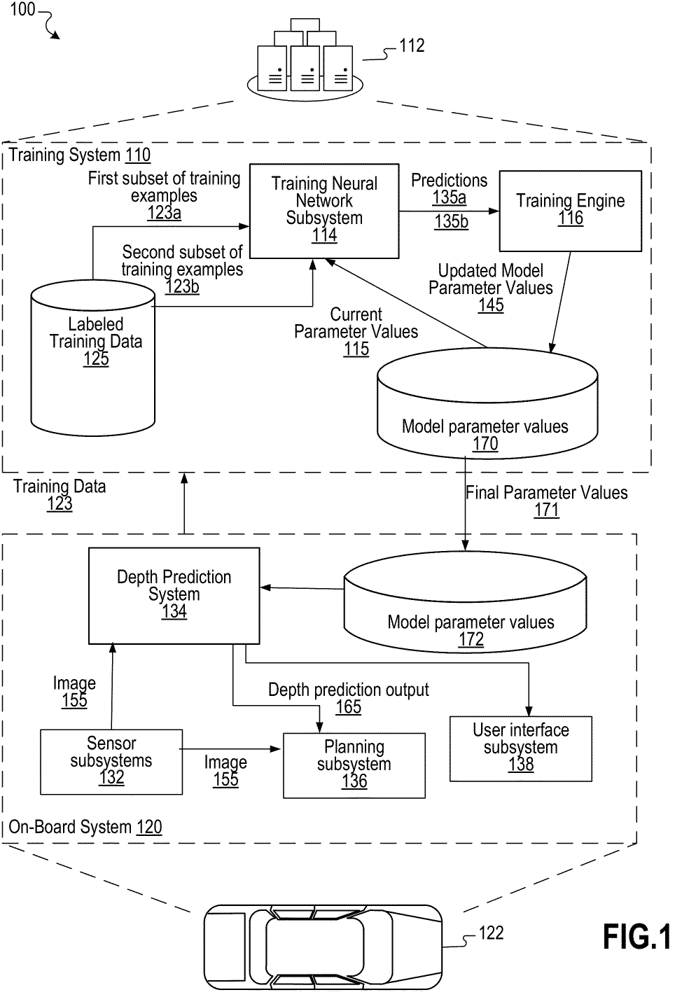

FIG. 1 is a diagram of an example computer system 100.

The computer system 100 can include a training system 110 and an on-board system 120. The on-board system 120 can be physically located on-board an agent 122. Being on-board the agent 122 means that the on-board system 120 includes some or all of components that travel along with the agent 122, e.g., power supplies, computing hardware, and sensors.

The agent 122 in FIG. 1 is illustrated as an automobile, but the on-board system 110 can be located on-board any appropriate vehicle or agent type.

In some cases, the agent 122 is an autonomous vehicle. An autonomous vehicle can be a fully autonomous vehicle that determines and executes fully-autonomous driving decisions in order to navigate through an environment. An autonomous vehicle can also be a semi-autonomous vehicle that uses predictions to aid a human driver. For example, the vehicle can autonomously apply the brakes if a prediction indicates that a human driver is about to collide with another vehicle. As another example, the vehicle can have an advanced driver assistance system (ADAS) that assists a human driver of the vehicle in driving the vehicle by detecting potentially unsafe situations and alerting the human driver or otherwise responding to the unsafe situation. As a particular example, the vehicle can alert the driver of the vehicle or take an autonomous driving action when an obstacle is detected, when the vehicle departs from a driving lane, or when an object is detected in a blind spot of the human driver.

Generally, the agent 122 uses visibility outputs to inform fully-autonomous or semi-autonomous driving decisions. For example, the agent 122 can autonomously apply the brakes if a visibility output indicates with an uncertainty satisfying a threshold that a human driver is about to navigate onto static obstacles, e.g., a paved sidewalk or other non-road ground surface. As another example, for automatic lane changing, the agent 122 can use visibility output(s) to analyze available space surrounding a target lane to ensure that there is no fast approaching traffic before starting a lane changing operation. The agent 122 can also use the visibility output to identify situations when the road is not occluded and thus trigger alerts to the driver.

The on-board system 120 can include one or more sensor subsystems 132. The sensor subsystems 132 include a combination of components that receive reflections of electromagnetic radiation. In particular, the sensor subsystems include one or more camera systems that capture images 155, i.e., that detect reflections of visible light and optionally one or more other types of systems e.g., laser systems that detect reflections of laser light, radar systems that detect reflections of radio waves, and camera systems that detect reflections of visible light.

The sensor subsystems 132 provide the captured images 155 to a depth prediction system 134.

The depth prediction system 134 implements the operations of each layer of a neural network trained to generate depth prediction outputs for some or all pixels in an input image 155. That is, the neural network receives as input a single image 155 and generates as output a depth prediction output for the image 155.

Each depth prediction output can include a respective estimated depth that estimates a distance between the sensor, i.e., the camera system that captured the image, and a portion of the scene depicted at the pixel in the image.

For example, the neural network can be a convolutional neural network that includes a first subnetwork that processes the image to generate a feature representation of the image. For example, the feature representation can be a feature map that includes a respective feature vector for each of a plurality of regions of the image 155.

The neural network can also include a depth estimate neural network head that processes the feature representation to generate the respective estimated depths for each of the plurality of pixels.

Optionally, the neural network can also include an uncertainty neural network head that processes the feature representation to generate a respective estimated uncertainty for each of the plurality of pixels. The estimated uncertainty for a given pixel is a score that measures how confident the neural network is in the estimated depth for the given pixel. For example, each uncertainty estimate can be a score between zero and one, inclusive, with a score of one indicating that the neural network is completely uncertain about the estimated depth and a score of zero indicating that the neural network is completely certain about the estimated depth.

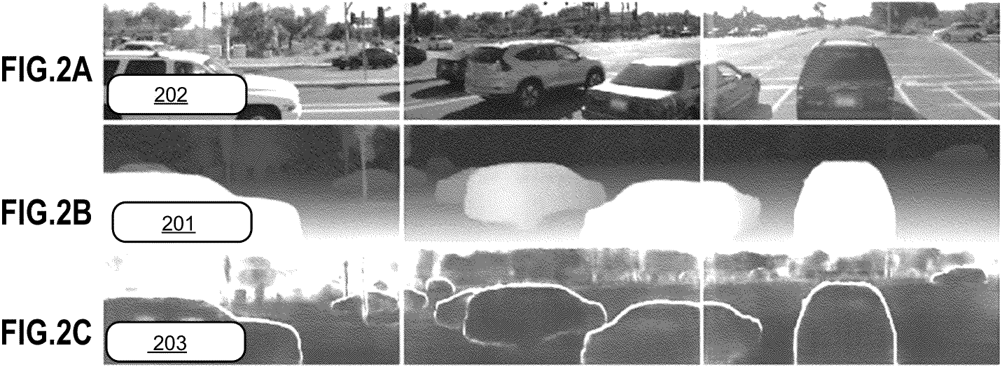

The neural network is described in more detail below with reference to FIGS. 2A-4.

The depth prediction system 134 can implement the operations of the neural network by loading a collection of model parameter values 172 that are received from the training system 110. Although illustrated as being separated, the model parameter values 170 and the software or hardware modules performing the operations may actually be located on the same computing device or, in the case of an executing software module, stored within the same memory device.

The depth prediction system 134 can use hardware acceleration or other special-purpose computing devices to implement the operations of one or more layers of the neural network. For example, some operations of some layers may be performed by highly parallelized hardware, e.g., by a graphics processing unit or another kind of specialized computing device. In other words, not all operations of each layer need to be performed by central processing units (CPUs) of the depth prediction system 134.

The depth prediction system 134 can communicate the depth prediction outputs to a planning subsystem 136. Optionally, the sensor subsystem 132 may communicate the captured image 155 to the planning subsystem 136.

The planning subsystem 136 can obtain a three-dimensional (3D) query point. For example, the 3D query point can be a point on a planned motion path of the agent 122 or another point of interest to the future navigation of the agent 122. The 3D query point can correspond to one or more pixels of the captured image 155. That is, the planning subsystem 136 can receive both a query point and data specifying the corresponding pixel for the query point. Alternatively, such correspondence between a 3D query point and a pixel in the image can be determined by the planning subsystem 136, for example, by performing a 3D calibration that registers the 3D query point in a world coordinate system to the pixel(s) in the image coordinate system. That is, the system can map the query point from a specified three-dimensional coordinate system, e.g., one that is centered at the agent 122 or at another 3d point, to the two-dimensional image coordinate system using calibration data that “calibrates” 2d points in the image coordinate system.

The planning subsystem 136 can then determine whether the 3D query point is visible or not in the captured image 155.

For example, the visibility output can be a binary indicator that has one value, e.g., one or zero, when the system predicts that the point is visible in the image and another, different value, e.g., zero or one, when the system predicts that the point is not visible in the image.

The planning subsystem 136 can compare the depth prediction output 165 which includes an estimated depth, d(u, v), for a corresponding pixel, at coordinates (u,v), of the captured image 155 of the 3D query point with a depth of the 3D query point, x′, i.e., a distance between the 3D query point and the sensor. In particular, if d(u, v) > x′, the query point is visible or in free space. If d(u, v) ≤ x′, the query point is not visible or occluded, where u and v are coordinates of the corresponding pixel in the image coordinate system, d() is the depth, and x′ represents the distance from the sensor to the query point in the sensor coordinate system.

When the neural network also generates uncertainty estimates, the system 136 can also use the uncertainty estimate for the corresponding pixel to generate the visibility output. In particular, the system 136 may calculate a modified estimated depth using the estimated depth and the estimated uncertainty. The modified estimated depth can be negatively correlated with the uncertainty so that the depth estimation can be more robust and reliable. The system 134 can compare the modified estimated depth with the distance between the query point and the sensor to determine the visibility output. A similar binary indicator can be used for the visibility output.

For example, if d(u, v)[1-Me(u,v)] > x′, the query point is visible or in free space, if d(u, v)[1-Me(u,v)] ≤ x′, the query point is not visible or occluded, where u and v are coordinates of the corresponding pixel in the image coordinate system, d() is the estimated depth, x′ represents the distance from the sensor to the query point in the sensor coordinate system, and where M is a variable safety margin and M ≥ 0, and e() represents the estimated uncertainty. That is, setting the safety margin M allows the system to determine visibility outputs more aggressively or conservatively, e.g., the modified estimated depth can be smaller when the safety margin is larger so that the visibility output is more conservative and is more likely to indicate that a query point is not visible.

The planning subsystem 136 can then use the visibility output 165 to make fully-autonomous or semi-autonomous driving decisions. For example, the planning subsystem 136 can generate a fully-autonomous plan to navigate on a highway or other road by querying the visibility output(s) to differentiate free or visible areas in the vicinity of the agent 122 from areas where there are occlusions. By identifying occlusions, during a turn operation, the vehicle can perform a necessary yield operation to a potential object, e.g., a car, a cyclist, or a pedestrian. As another example, the planning subsystem 136 can generate a semi-autonomous plan for a human driver to navigate the car using the visibility output(s).

A user interface subsystem 138 can receive depth prediction output 165 and can generate a user interface display, e.g., on a graphic user interface (GUI) that indicates the depth map of nearby objects, e.g., a road or a nearby vehicle. For example, the user interface subsystem 138 can generate a user interface presentation having image or video data containing a representation of the regions of space that have depth value satisfying a certain threshold. An on-board display device can then display the user interface presentation for passengers or drivers of the agent 122.

The depth prediction system 134 can also use the image data 155 to generate training data 123. The on-board system 120 can provide the training data 123 to the training system 110 in offline batches or in an online fashion, e.g., continually whenever it is generated.

The training system 110 can be hosted within a data center 112, which can be a distributed computing system having hundreds or thousands of computers in one or more locations.

The training system 110 can include a training neural network subsystem 114 that can implement the operations of each layer of a neural network that is designed to make depth predictions from input image data. The training neural network subsystem 114 can include a plurality of computing devices having software or hardware modules that implement the respective operations of each layer of the neural network according to an architecture of the neural network.

The training neural network generally has the same architecture and parameters as the on-board neural network. However, the training system 110 need not use the same hardware to compute the operations of each layer. In other words, the training system 110 can use CPUs only, highly parallelized hardware, or some combination of these.

The training neural network subsystem 114 can receive as input training examples 123a and 123b that have been selected from a set of labeled training data 125.

Each of the training examples 123 includes a training image and a ground truth depth output for the training image that assigns a respective ground truth depth to at least a portion of the pixels in the training image. The respective ground truth depths can be obtained from light detection and ranging (LiDAR) scans projected onto and matching scenes of the training images in the training examples. The LiDAR images can be taken by the on-vehicle sensor subsystem 132, e.g., by laser sensors.

In some cases, the training examples can be separated into two different subsets 123a and 123b.

For each training example in the first subset 123a, the training neural network subsystem 114 can process the training image in the training example using the neural network to generate a training depth prediction output that includes a respective estimated training depth and a respective estimated training uncertainty for each of the pixels in the training image in the training example.

For each training example in a second subset of the training examples 123b, the training neural network subsystem 114 can process the training image in the training example using the neural network to generate a training depth prediction output that includes a respective estimated training depth and a respective estimated training uncertainty for the pixels of the training image in the training example.

A training engine 116 can analyze the predictions from the first and second subset of training examples 135a, 135b and compare them to the labels in the training examples 123. In particular, the training engine 116 can, for each training example in the second subset of the training examples 123b, compute a respective target uncertainty for each of the pixels in the training image from an error between (i) the respective ground truth depth for the pixel and (ii) the respective estimated training depth for the pixel, i.e., so that the target uncertainty is larger when the error is larger. For example, the target uncertainty can be equal to the error divided by a scaling factor to ensure that the target uncertainty falls in a certain range, e.g., zero to 1.

A training engine 116 can determine a first update to parameters of the neural network by computing gradients of a depth objective, i.e., an objective function that measures errors between the respective estimated training depths and the respective ground truth depths for the training examples in the first subset. Similarly, the training engine 115 can determine a second update to the parameters of the neural network by computing gradients of an uncertainty objective, i.e., the same objective function or a different objective function that measures errors between the respective estimated training uncertainties and respective target uncertainties for the training examples in the second subset.

Based on the first update and/or second update of the neural network, the training engine 116 then generates updated model parameter values 145 by using an appropriate updating technique, e.g., stochastic gradient descent with backpropagation. The training engine 116 can then update the collection of model parameter values 170 using the updated model parameter values 145.

The system can repeatedly perform this updating on training examples sampled from the first and second subsets to train the neural network.

In some other cases, the training examples are not separated into subsets, and the training system 110 trains the neural network by making use of both the depth objective and the uncertainty objective to compute a single update for each training example.

After training is complete, the training system 110 can provide a final set of model parameter values 171 to the on-board system 120 for use in making fully autonomous or semi-autonomous driving decisions. The training system 110 can provide the final set of model parameter values 171 by a wired or wireless connection to the on-board system 120.

FIGS. 2A-2C illustrate examples of depth prediction outputs and estimated uncertainties associated from images 202.

The images 202 can be camera images taken from the same camera or different cameras in the sensor subsystem 120 in FIG. 1. The different cameras can be positioned at different locations of the agent 122. The camera images 202 can capture a scene of the environment with trees, cars, roads, paved sidewalks, and grass areas, etc.

The camera images 202 can capture a portion of a road that is relatively far from the location of the camera and is farther than can be sensed by LiDAR or radar sensors. Therefore, it is beneficial to estimate depth thus visibility from the camera images to allow depth values to be available for locations that cannot be sensed by LiDAR or radar.

The system can provide the camera images 202 as input to a neural network trained to identify depths 201 and associated uncertainty estimates 203.

In particular, in FIGS. 2A-2C, larger depth values are represented with darker colors. Thus, for example, as shown in FIG. 2B, the estimated depth of the nearby cars are less than the depth of the farther away sidewalk and trees because the cars are represented with a relatively lighter color. More generally, however, depths in a depth image can be color-coded or represented in grayscale in any appropriate way. Different shade or color may represent different depths, and the depth image may be presented by the user interface subsystem 138 to the user.

For the uncertainty 203 associated with depth estimation, as shown in FIG. 2C, points with greater uncertainty are represented with lighter colors. Thus, the edge of the nearby cars has a higher uncertainty than the other regions on the cars. Such uncertainty may be partly caused by the partial volume effect of the image 202, which is that a given pixel may include part of the car and also part of the other objects.

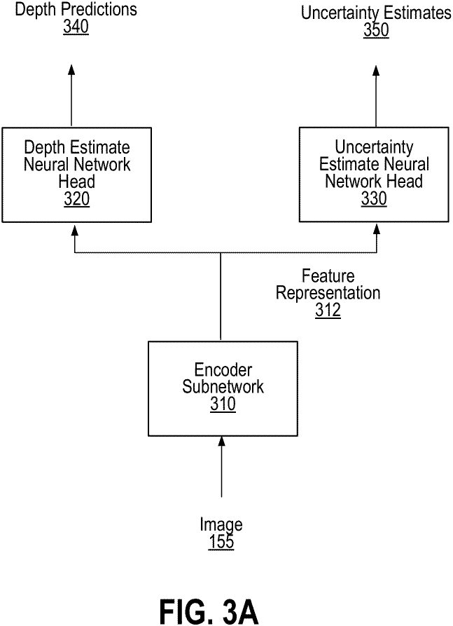

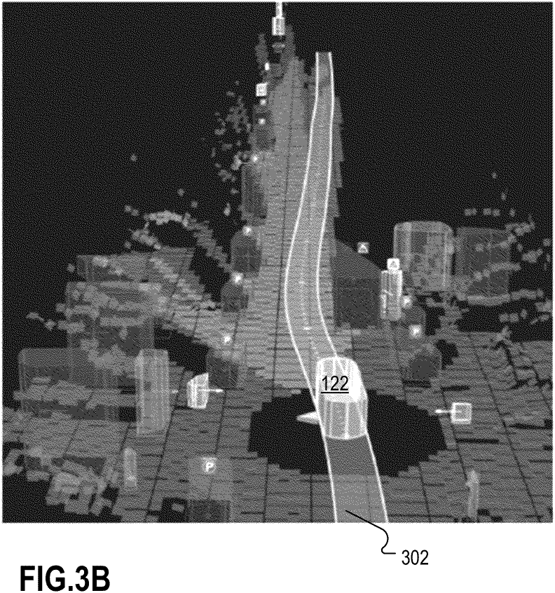

FIG. 3A shows an example architecture 300 of the neural network.

As shown in FIG. 3A, the neural network includes an encoder subnetwork 310 that receives a camera image 155 and processes the camera image 155 to generate a feature representation 312 of the image 155. For example, the feature representation 312 can be a feature map that includes a respective feature vector for each of multiple regions within the image 155. In some cases, each region corresponds to a different pixel of the image 155 while in other cases, each region includes multiple pixels from the image 155. As one example, the encoder subnetwork 310 can be a convolutional encoder, a self-attention encoder, or an encoder that has both convolutional and self-attention layers.

The neural network also has a depth estimate neural network head 320 that receives the feature representation 312 and processes the representation 312 to generate depth predictions 340, i.e., to generate depth estimates for some or all of the pixels of the image 155. For example, the depth estimate neural network head 320 can be a fully-convolutional neural network or can be a neural network that has both convolutional and fully-connected layers.

The neural network also has an uncertainty estimate neural network head 330 that receives the feature representation 312 and processes the representation 312 to generate uncertainty estimates 350, i.e., to generate uncertainty estimates for some or all of the pixels of the image 155. For example, the uncertainty estimate neural network head 330 can be a fully-convolutional neural network or can be a neural network that has both convolutional and fully-connected layers.

As described above, the neural network heads 320 and 330 can be trained on different subsets, e.g., randomly selected subsets, of a set of training data.

For example, the system can first train the neural network head 320 and the encoder subnetwork 310 on a first subset of the training data to generate depth estimates, i.e., on a loss function that measures errors between depth predictions and ground truth depths. The system can then train the neural network head 330 to generate uncertainty estimates on a second subset of the training data while holding the neural network head 320 and the encoder subnetwork 310 fixed, i.e., on a loss function that measures errors between uncertainty estimates and target uncertainty estimates computed as described above.

As another example, each batch of training data can include training examples from both the first and second subsets, and the system can jointly train the neural network head 320, the encoder subnetwork 310, and the neural network head 330 on an objective function that measures both (i) errors between depth predictions and ground truth depths and (ii) errors between uncertainty estimates and target uncertainty estimates computed as described above.

As yet another example, the system can alternate between training the neural network on batches of training examples from the first subset and batches of training examples from the second subset.

As yet another example, the training examples are not separated into subsets, and the training system trains the neural network by making use of both the depth objective and the uncertainty objective to compute a single update for each batch of training examples. That is, the system uses an objective function that measures both (i) errors between depth predictions and ground truth depths and (ii) errors between uncertainty estimates and target uncertainty estimates computed as described above for all of the training examples in the batch.

FIG. 3 shows an example of visibility predictions generated for a region of the environment that is in the vicinity of the planned motion trajectory 302 of the agent 122.

As described above, the system can obtain depth images and 3D query points that are in front of the agent and/or along candidate future motion paths of the agent.

The system can then determine visibility outputs for pixels corresponding to the 3D query points based on the respective estimated depths of the pixels and the distances from the query points to the camera sensor. Based on the visibility outputs, the system can determine whether a 3D query point in the environment is visible or not, thereby generating a future motion trajectory 302 that includes only 3D query points that are visible as shown in FIG. 3B.

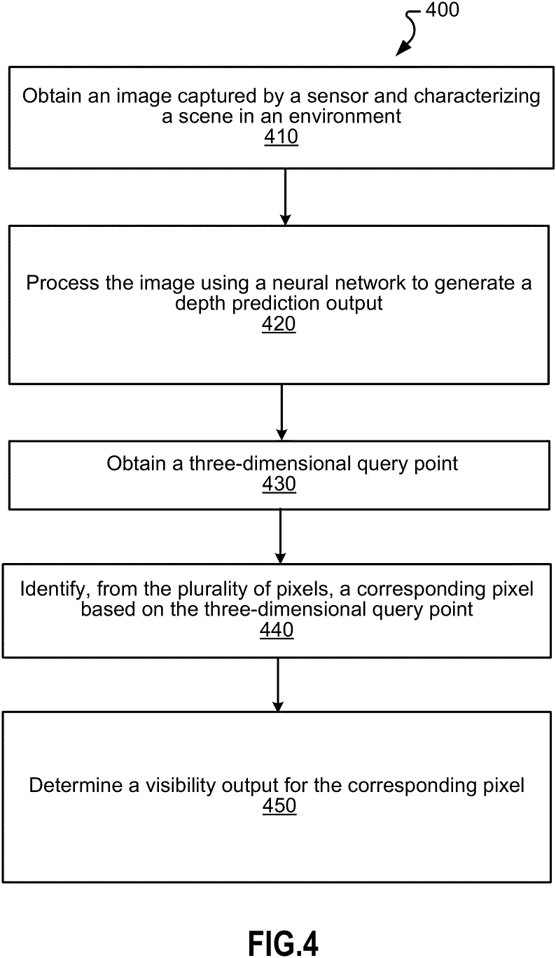

FIG. 4 is a flowchart of an example process 400 for generating visibility outputs from an image using the neural network. The example process in FIG. 4 can use a neural network that has already been trained to estimate depths in camera images. The example process can thus be used to make predictions from unlabeled input, e.g., a single image taken by an on-board camera. The process will be described as being performed by an appropriately programmed neural network system.

The system obtains an image captured by a sensor and characterizing a scene in an environment (410). The image can be a camera image generated from the camera subsystem in a sensor subsystem of an agent, e.g., a vehicle.

The system can process the image using a neural network, e.g., a deep neural network, to generate a depth prediction output that includes a respective estimated depth for each of a plurality of pixels in the image (420).

The depth prediction output can estimate a distance between the camera and a portion of the scene depicted at the pixel in the image.

The depth prediction output can further include a respective estimated uncertainty for each of the plurality of pixels in the image that estimates uncertainty associated with the respective estimated depth.

The system can obtain one or more 3D query points (430). For example, the 3D query points can be points along a candidate future motion trajectory of the agent. Each query point can be represented in a three-dimensional coordinate system, e.g., centered at the agent or at a different, fixed point in the environment.

For each query point, the system can identify a corresponding pixel for the query point in the image (440). The corresponding pixel for a given query point is the pixel to which the query point is projected when the query point is mapped from the three-dimensional coordinate system to the two-dimensional image coordinate system.

For each query point, the system can determine a visibility output for the corresponding pixel based on the respective estimated depth for the corresponding pixel and a distance between the three-dimensional query point and the sensor (450). The system can compute the distance between the three-dimensional query point and the sensor by, e.g., computing Euclidean distance between a point on the sensor, e.g., a specified point on the surface of the sensor or at the center of the sensor, in the three-dimensional coordinate system.

The visibility output can characterize whether the three-dimensional query point is visible in the image or not.

For example, the visibility output can be a binary indicator that has one value, e.g., one or zero, when the system predicts that the point is visible in the image and another, different value, e.g., zero or one, when the system predicts that the point is not visible in the image.

As described above, the depth outputs include, for a given pixel at coordinates (u,v) in the image, an estimated depth, d(u,v). To generate the visibility output for the query point corresponding to the given pixel, the system can compare d(u,v) to the depth of the 3D query point, x′, i.e., a distance between the 3D query point and the sensor. In particular, if d(u, v) > x′, the query point is visible or in free space. If d(u, v) ≤ x′, the query point is not visible or occluded, where u and v are coordinates of the corresponding pixel in the image coordinate system, d() is the depth, and x′ represents the distance from the sensor to the query point in the sensor coordinate system.

When the neural network also generates uncertainty estimates, the system can also use the uncertainty estimate for the corresponding pixel to generate the visibility output. In particular, the system 136 calculate a modified estimated depth using the estimated depth and the estimated uncertainty. The modified estimated depth can be negatively correlated with the uncertainty so that the depth estimation can be more robust and reliable. That is, the modified estimated depth can be smaller when the uncertainty is larger, and vice versa. The system can compare the modified estimated depth with the distance between the query point and the sensor to determine the visibility output. A similar binary indicator can be used for the visibility output.

For example, if d(u, v)[1-Me(u,v)] > x′, the query point is visible or in free space, if d(u, v)[1-Me(u,v)] ≤ x′, the query point is not visible or occluded, where u and v are coordinates of the corresponding pixel in the image coordinate system, d() is the estimated depth, x′ represents the distance from the sensor to the query point in the sensor coordinate system, and where M is a variable safety margin and M ≥ 0, and e() represents the estimated uncertainty. That is, setting the safety margin M allows the system to determine visibility outputs more aggressively or conservatively, e.g., the modified estimated depth can be smaller when the safety margin is larger so that the visibility output is more conservative and is more likely to indicate that a query point is not visible.

The visibility outputs can be used by the planning subsystem of the on-board system to control the agent, i.e., to plan the future motion of the vehicle based on the visibility predictions in the environment. As another example, the visibility output may be used in simulation and assist in controlling the simulated vehicle, in testing the realism of certain situations encountered in the simulation, and in ensuring that the simulation includes surprising interactions that are likely to be encountered in the real-world. When the planning subsystem receives the visibility prediction outputs, the planning sub system can use the prediction output to generate planning decisions that plan a robust, safe, and comfortable future trajectory of the autonomous vehicle, i.e., to generate a planned vehicle path.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, off-the-shelf or custom-made parallel processing subsystems, e.g., a GPU or another kind of special-purpose processing subsystem. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed:

1. A computer-implemented method comprising:
obtaining an image captured by a sensor and characterizing a scene in an environment, the image comprising a plurality of pixels;
processing the image using a deep neural network to generate a depth prediction output that comprises a respective estimated depth for each of the plurality of pixels in the image that estimates a distance between the sensor and a portion of the scene depicted at the pixel in the image;
obtaining a three-dimensional query point;
identifying, from the plurality of pixels, a corresponding pixel based on the three-dimensional query point; and
determining a visibility output for the corresponding pixel based on the respective estimated depth for the corresponding pixel and a distance between the three-dimensional query point and the sensor, wherein the visibility output characterizes whether the three-dimensional query point is visible in the image.

2. The method of claim 1, wherein the depth prediction output further comprises a respective estimated uncertainty for each of the plurality of pixels in the image that estimates uncertainty associated with the respective estimated depth.

3. The method of claim 2, wherein determining the visibility output for the corresponding pixel is further based on the respective estimated uncertainty.

4. The method of claim 1, wherein the three-dimensional query point is in a sensor coordinate system, and wherein the corresponding pixel is in an image coordinate system.

5. The method of claim 3, wherein determining the visibility output for the corresponding pixel based on the respective estimated depth, the respective estimated uncertainty, and the distance between the three-dimensional query point and the sensor comprises:
generating a respective modified estimated depth based on a predetermined safety margin, the respective estimated uncertainty, and the respective estimated depth.

6. The method of claim 5, wherein the respective modified estimated depth is negatively correlated with a multiplication of the respective estimated uncertainty and the predetermined safety margin.

7. The method of claim 5, wherein determining the visibility output for the corresponding pixel based on the respective estimated depth, the respective estimated uncertainty, and the distance between the three-dimensional query point and the sensor comprises:
comparing the respective modified estimated depth with the distance between the three-dimensional query point and the sensor;
in response to determining that the respective modified estimated depth is greater than the distance, assigning the visibility output as free space; and
in response to determining that the respective modified estimated depth is smaller than the distance, assigning the visibility output as occupied.

8. The method of claim 1, wherein the sensor is an on-vehicle camera and the image captured by the sensor comprises a single image.

9. The method of claim 1, wherein the deep neural network is a convolutional neural network that includes a first subnetwork that processes the image to generate a feature representation of the image, a depth estimate neural network head that processes the feature representation to generate the respective estimated depths for the plurality of pixels, and an uncertainty estimate neural network head that processes the feature representation to generate the respective estimated uncertainties for the plurality of pixels.

10. A system comprising one or more computers and one or more storage devices storing instructions that when executed by the one or more computers cause the one or more computers to perform operations comprising:
obtaining an image captured by a sensor and characterizing a scene in an environment, the image comprising a plurality of pixels;
processing the image using a deep neural network to generate a depth prediction output that comprises a respective estimated depth for each of the plurality of pixels in the image that estimates a distance between the sensor and a portion of the scene depicted at the pixel in the image;
obtaining a three-dimensional query point;
identifying, from the plurality of pixels, a corresponding pixel based on the three-dimensional query point; and
determining a visibility output for the corresponding pixel based on the respective estimated depth for the corresponding pixel and a distance between the three-dimensional query point and the sensor, wherein the visibility output characterizes whether the three-dimensional query point is visible in the image.

11. The system of claim 10, wherein the depth prediction output further comprises a respective estimated uncertainty for each of the plurality of pixels in the image that estimates uncertainty associated with the respective estimated depth.

12. The system of claim 11, wherein determining the visibility output for the corresponding pixel is further based on the respective estimated uncertainty.

13. The system of claim 10, wherein the three-dimensional query point is in a sensor coordinate system, and wherein the corresponding pixel is in an image coordinate system.

14. The system of claim 12, wherein determining the visibility output for the corresponding pixel based on the respective estimated depth, the respective estimated uncertainty, and the distance between the three-dimensional query point and the sensor comprises:
generating a respective modified estimated depth based on a predetermined safety margin, the respective estimated uncertainty, and the respective estimated depth.

15. The system of claim 14, wherein the respective modified estimated depth is negatively correlated with a multiplication of the respective estimated uncertainty and the predetermined safety margin.

16. The system of claim 14, wherein determining the visibility output for the corresponding pixel based on the respective estimated depth, the respective estimated uncertainty, and the distance between the three-dimensional query point and the sensor comprises:
comparing the respective modified estimated depth with the distance between the three-dimensional query point and the sensor;
in response to determining that the respective modified estimated depth is greater than the distance, assigning the visibility output as free space; and
in response to determining that the respective modified estimated depth is smaller than the distance, assigning the visibility output as occupied.

17. The system of claim 10, wherein the sensor is an on-vehicle camera and the image captured by the sensor comprises a single image.

18. The system of claim 10, wherein the deep neural network is a convolutional neural network that includes a first subnetwork that processes the image to generate a feature representation of the image, a depth estimate neural network head that processes the feature representation to generate the respective estimated depths for the plurality of pixels, and an uncertainty estimate neural network head that processes the feature representation to generate the respective estimated uncertainties for the plurality of pixels.

19. One or more computer-readable storage media storing instructions that when executed by one or more computers cause the one or more computers to perform operations comprising:
obtaining an image captured by a sensor and characterizing a scene in an environment, the image comprising a plurality of pixels;
processing the image using a deep neural network to generate a depth prediction output that comprises a respective estimated depth for each of the plurality of pixels in the image that estimates a distance between the sensor and a portion of the scene depicted at the pixel in the image;
obtaining a three-dimensional query point;
identifying, from the plurality of pixels, a corresponding pixel based on the three-dimensional query point; and
determining a visibility output for the corresponding pixel based on the respective estimated depth for the corresponding pixel and a distance between the three-dimensional query point and the sensor, wherein the visibility output characterizes whether the three-dimensional query point is visible in the image.

20. The computer-readable storage media of claim 19, wherein the depth prediction output further comprises a respective estimated uncertainty for each of the plurality of pixels in the image that estimates uncertainty associated with the respective estimated depth.
